(19) United States
(12) Patent Application Publication
(10) Pub. No.: US 2011/0187524 A1
(43) Pub. Date: Aug. 4, 2011

(54) METHOD AND SYSTEM FOR COMMUNICATING WITH INSTRUMENTED TOOLS UTILIZED BY EMERGENCY RESPONDERS

(75) Inventor: Edward Leo Cochran, III, Minneapolis, MN (US)

(73) Assignee: Honeywell International Inc., Morristown, NJ (US)

(21) Appl. No.: 12/698,350

(22) Filed: Feb. 2, 2010

(51) Int. Cl. G08B 1/08

(52) U.S. Cl. 340/539.1

(57) ABSTRACT

An instrumented emergency response tool system and method for wirelessly communicating emergency response condition and location information to a team of emergency responders. An emergency response tool utilized by an emergency responder can be integrated with one or more sensors to detect at least one parameter with respect to an emergency response situation or hazardous environment. The data associated with the sensing parameter can be transferred to an emergency responder radio communication device via a wireless communication medium such as, for example, Bluetooth communication technology. A signal representative of the transferred data from the radio communication device can be transmitted to a base station as radio signals. The radio communication device can be integrated with emergency responder gear to enable location and health monitoring and to provide useful information to the team of emergency responders.

### TECHNICAL FIELD

Embodiments are generally related to firefighting tools, devices, and systems. Embodiments are also related to the field of wireless communications. Embodiments are additionally related to the implementation of instrumented tools utilized by emergency responders such as, for example, firefighters and the communication of such tools with firefighters and their officers on the fireground.

### BACKGROUND OF THE INVENTION

Large facilities may be subject to incidents or other events that need to be handled rapidly and efficiently by first responders such as, for example, firefighters, police officers, search and rescue teams, and so forth. The workload involved in firefighting and rescue work is difficult, and events such as accidents and fires can occur at any time, in any place, and under a variety of circumstances.

Emergency responders such as firefighters typically require the use of numerous tools such as, for example, forcible entry tools, demolition tools such as pike poles, and fire hoses to assist in managing an incident. A common problem encountered by emergency responders is the difficulty in capturing and transmitting accurate and up to date information to a command center and then providing such information to the first responder on site at the scene of an incident. For example, it would be helpful to commanders outside the fire building to know whether firefighters operating inside are in need of breathing air replenishment. In situations involving a fire hose, for example, it is very important to maintain constant water pressure in the nozzle associated with the hose. If the pressure changes without warning (e.g., because the hose becomes kinked, or unkinked), a firefighter or other user can be faced with either not enough flow to perform the job or a potentially dangerous over-pressure situation.

Another common problem faced by firefighters is the difficulty in determining whether a fire is behind walls or in other concealed spaces. Firefighters may therefore unnecessarily demolish walls in an attempt to locate fire. Existing tools such as thermal imaging cameras can help, but are costly, time consuming to use, and cumbersome to carry.

Based on the foregoing, it is believed that a need exists for an improved instrumented emergency response tool system and method. A need also exists for wirelessly communicating information from the emergency response tool to the firefighter using the tool, as well as to a team of emergency responders without increasing the response workload, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved instrumented emergency response tool.

It is another aspect of the disclosed embodiments to provide for an improved system and method for continuously sensing and monitoring an emergency response condition and location in dangerous situations in order to enhance the safety of the emergency responder.

It is a further aspect of the disclosed embodiments to provide for an improved system and method for wirelessly communicating emergency response condition and location information from an instrumented emergency response too to an emergency responder such as, for example, a firefighter.

It is an additional aspect of the disclosed embodiments to provide for an improved system and method for wirelessly communicating emergency response condition and location information from an instrumented emergency response tool to a team of emergency responders.

The aforementioned aspects and other objectives and advantages can now be achieved as described herein. A system and method are disclosed for wirelessly communicating emergency response condition and location information to a team of emergency responders. A collection of emergency response tools (e.g. breathing apparatus, fire nozzle, pike pole, etc.) held by an emergency responder such as a firefighter can be integrated with one or more sensors to detect at least one parameter with respect to a hazardous environment. Such sensors, configured in association with the emergency response tool, can also be employed to monitor sensing parameters such as, for example, air pressure, water pressure, flow rate, temperature, gas concentration, pulse rate, and hazardous gasses. Data associated with the sensing parameter(s) can be transferred to an emergency responder radio communication device via a wireless communication technology (e.g., Bluetooth). A signal representative of the transferred data from the radio communication device can be transmitted to other radios using radio signals. The radio communication device can be integrated with emergency responder gear to enable location and health monitoring and to provide useful information without duplicative infrastructure costs.

In an embodiment, an instrumented fire nozzle tool, for example, employs wireless technology to communicate with the radio communications device, and can report water pressure and flow rate data to a motor pump operator. The sensor can be mounted in a nozzle associated with the fire hose tool and can be configured in a self-contained arrangement to report accurate information with respect to conditions at the end of the hose. This information can be used to automatically vary the water flowing to the hose in order to maintain constant pressure at the nozzle, which is superior to the current, open loop estimation methods.

In another embodiment, an instrumented pike pole tool can report temperature, gas concentration, or other useful information via wireless communications to the emergency responder. For example, the tip of a pike pole can be pushed through a wall, and the tool can then report the temperature behind the wall to the firefighter using the firefighter's radio, thus helping the firefighter to determine whether the wall needs to be opened. In addition, the instrumented firefighting tool held by the emergency responder is configured to collect and communicate information to the base station via the firefighter's radio communication device in order to, for example, inform command staff about gas concentrations, explosion risks, and other hazards. Such a base station can be configured as a data analysis center that gathers and analyzes data transmitted from the radio communications device and then obtains conclusions by analysis. One or more base station operators can interact very closely with such a system to extrapolate data.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of an instrumented fire hose tool associated with a fire engine, in accordance with the disclosed embodiments;

FIG. 2 illustrates a perspective view of the instrumented fire hose tool, in accordance with the disclosed embodiments;

FIG. 3 illustrates a perspective view of an instrumented pike pole tool, in accordance with the disclosed embodiment; and

FIG. 4 illustrates a high level flow chart of operations illustrating logical operational steps of a method for wirelessly communicating firefighter condition and location information to a firefighting team, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

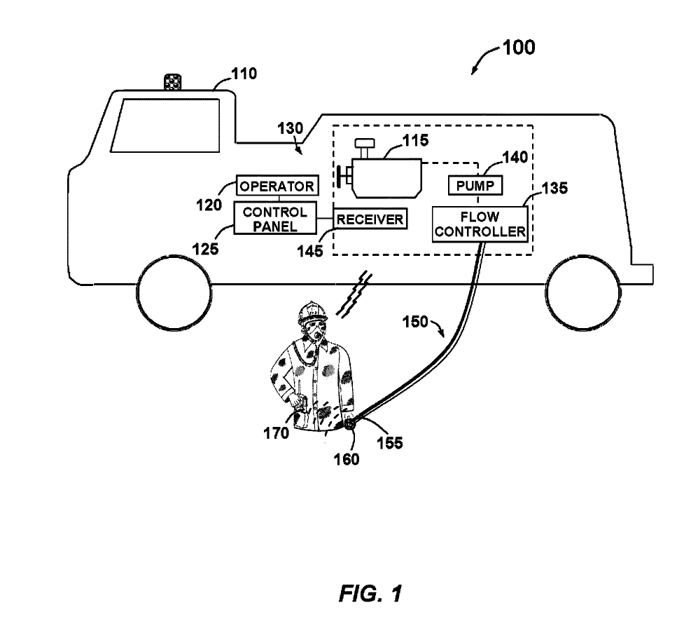

The disclosed embodiments may be employed to sense one or more parameters such as pressure, flow rate, temperature, gas concentration, pulse rate, or the like, to thereby provide enhanced management with respect to an emergency response system. The instrumented firefighting tool system and method described herein can wirelessly communicate such parameters, firefighter condition, and location information to a base station. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the present invention.

FIG. 1 illustrates a perspective view of a firefighting fluid delivery system 100 associated with an instrumented fire hose tool 150, in accordance with the disclosed embodiments. Note that in FIGS. 1-4, identical parts or elements are generally indicated by identical reference numerals. Note additionally that the discussion herein with respect to firefighters, firefighting, and instrumented firefighting tools relates to one particular type of emergency response system and emergency responders. That is, it can be appreciated that the method and system disclosed herein apply to other types of emergency responders and emergency response systems, such as those involving paramedics, doctors, police officers, private security guards, and military personnel and situations. The embodiments are thus not limited to firefighters and firefighting, but involve a broad host of emergency responders and emergency response situations. The discussion herein of firefighters, firefighting, and firefighter tools is presented for general exemplary purposes only.

As indicated in FIG. 1, a fire hose tool 150 is configured to provide enhanced control over the delivery of firefighting fluid by monitoring the parameters such as pressure, flow rate, temperature, or the like. A fire engine 110 includes a flow controller 135, which controls water supply from a fluid storage tank 115 or external water supply via a pump 140, and the fire hose tool 150. The fire engine 110 further includes a control panel 125, which includes various gauges and controls for controlling the operation of the pump 140, which pumps the firefighting fluid, for example, water, from the truck's storage tank 115. Note that the fire engine 110 may be any type of fire truck, including an aerial truck with the monitor mounted to the ladder or other extendable structure.

The fire hose tool 150 can be configured to include one or more sensors such as a sensor 155 mounted in proximity to a nozzle 160. The sensor 155 that is configured in association with the fire hose tool 150 can be employed to monitor the parameters with respect to a hazardous environment. Note that the sensor 155 described herein may constitute, for example, a pressure sensor, a temperature sensor, a flow rate sensor, a sensor for detecting hazardous gases, and/or other types of sensors, depending upon design considerations. It can be appreciated that other types of sensors may be utilized in place of the suggested sensor.

The sensor 155 directly measures water pressure and flow rate at the nozzle 160 and provides such information to a control panel 125 for use by an operator 120. The operator 120 can read the pressure and manually adjust the pump 140. The sensor 155 provides, optionally, additional pressure monitoring locations to locate problems in the tool 150 such as kinks in the hose and leaks. The instrumented firefighting tool 150 employs a wireless technology to communicate with a firefighter radio communication device 170 that transmits messages back to a base station 130. Note that the instrumented firefighting tool 150 normally employs a wireless Bluetooth communication between the sensor 155 and the radio communication device 170.

In general, Bluetooth is an open wireless protocol for exchanging data over short distances (using short length radio waves) from fixed and mobile devices, creating personal area networks (PANs). Bluetooth utilizes a radio technology called frequency-hopping spread spectrum, which chops up the data being sent and transmits chunks of it on up to 79 frequencies. Bluetooth provides a way to connect and exchange information between devices such as mobile phones, telephones, laptops, personal computers, printers, Global Positioning System (GPS) receivers, digital cameras, and video game consoles through a secure short-range radio frequency bandwidth.

The radio communication device 170 is in radio communication with the base station 130 located remotely. The radio communication device 170 transmits the sensed parameters to the base station 130 via a receiver unit 145 located near the pump 140 preferably on the fire engine 110. The base station operator 120 assists the firefighter in directing with the best possible solutions and suggestions based on the sensed parameters, and the valve associated with the base station 130 can be controlled automatically.

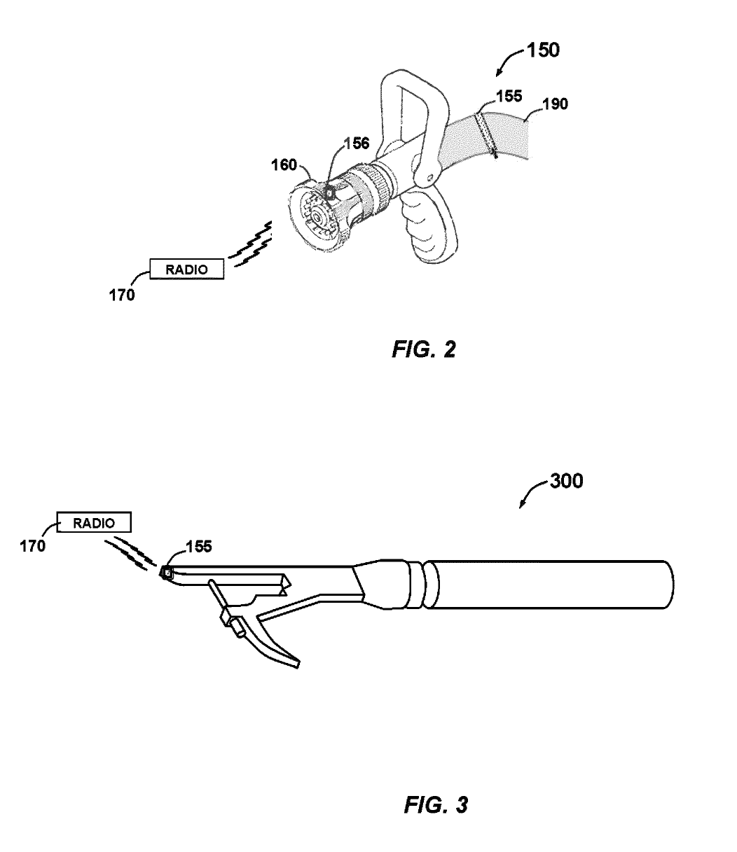

FIG. 2 illustrates a perspective view of the instrumented fire hose tool 150, in accordance with the disclosed embodiments. The sensor 155 can be mounted in proximity to the nozzle 160 associated with the fire hose tool 150 and is self-contained and reports accurate information with respect to conditions at the end of a hose 190. The sensor 155 can also be in the form of a universal adaptor installed between the hose 190 and the nozzle 160.

Note that a sensor 156 (or additional sensors of the same type) can be located at other points of the firefighting tool 150. Sensor 156 is similar to that of 155, albeit located in a different area of the firefighting tool 150. Sensors such as, for example, sensor 155 and/or sensor 156, can be configured into either the nozzle 160 itself or into a coupling at the end of the hose 190 of the nozzle 160 and are not free floating.

Note that the embodiments discussed herein generally relate to a fire hose tool. It can be appreciated, however, that such embodiments can be implemented in the context of other systems and tools, and are not limited to the fire hose tool. The discussion of fire hose tools, as utilized herein, is presented for general illustrative purposes only.

The sensor 155 generates signals that are proportional to the magnitude of the pressure associated with the firefighting fluid at the nozzle 160 and, more specifically, at inlet of the nozzle 160. It should be understood that various sensors can be mounted in proximity to the nozzle 160 in order to measure the parameter of the firefighting fluid, such as the flow rate, and/or temperature of the firefighting fluid, and similarly provide feedback to the control panel 125. Further, the sensor 155 is in communication with the radio communication device 170 which includes a wireless transmitter such as an RF transmitter, and transmits the signals that are generated by sensor 155 to the control panel 125.

FIG. 3 illustrates a perspective view of an instrumented pike pole tool 300, in accordance with the disclosed embodiment. A firefighter can utilize the pike pole tool 300 to pierce a hole in a ceiling of a room of a building that is on fire. Additionally, several of the firefighting tools may be attached to the same pike pole 300 to use one for pushing the pole and one for pulling the pole, or to enable several firefighters to work together on the same pole. The pike pole tool 300 can be configured to include one or more sensors such as the sensor 155. The sensor 155 that is configured in association with the pike pole tool 300 can be employed to monitor the parameters with respect to the hazardous environment and can report temperatures, gas concentrations, or other useful information via Bluetooth technology to the firefighter. The pike pole tool 300 in association with the sensor 155 can track, locate, and communicate the working conditions with respect to the firefighter 165 in real time.

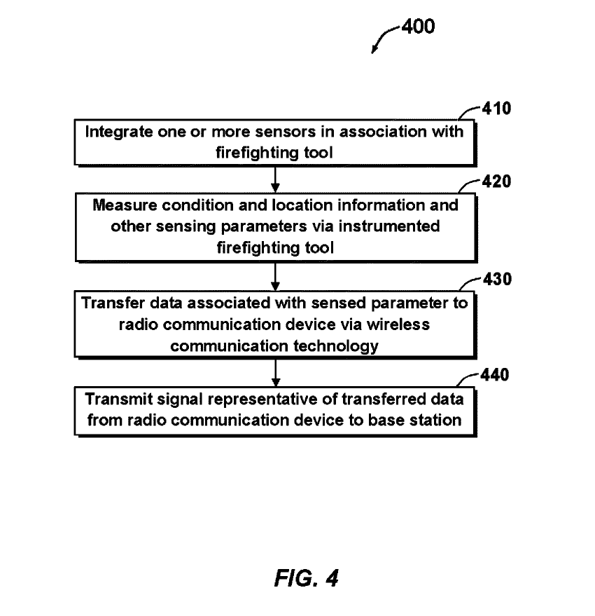

FIG. 4 illustrates a high level flow chart of operations illustrating logical operational steps of a method 400 for wirelessly communicating firefighter condition and location information to a firefighting team, in accordance with the disclosed embodiments. A firefighting tool such as, for example, fire hose tool 155 or pike pole tool 300 held by a firefighter can be integrated with one or more sensors, as depicted at block 410. The firefighter condition and location information with respect to a hazardous environment can be sensed, as indicated at block 420. The sensors that are configured in association with the firefighting tool can also be employed to monitor sensing parameters such as, for example, pulse rate, body temperature, air temperature, CO₂, and other hazardous gasses with respect to the environment.

The data associated with the parameter can be transferred to the firefighter radio communications device 170 via a wireless communication technology (e.g., Bluetooth), as illustrated at block 430. A signal representative of the transferred data from the firefighter radio communication device 170 can be transmitted to a base station as radio signals, as depicted at block 440. The radio communication device 170 can also be integrated to a firefighter's gear to enable location and health monitoring and to provide useful information without duplicative infrastructure costs.

The instrumented firefighting tool carried by the firefighter can be able to collect information and communicate them back to the base station via the radio communication device 170 which can prevent potential gas related explosions and other catastrophes. The base station is a data analysis center that gathers and analyzes the data sent by the radio communication device 170 and draws conclusions by the analysis. The base station operators interact with the system very closely to extrapolate data. The instrumented firefighting tool system and method described herein provides an improved smart firefighter tools that leverages technology for radio enabled sensor suites and provide useful information to firefighting teams without increasing workload for firefighters.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims. For example, in some embodiments the disclosed sensors can be integrated with a breathing apparatus for health monitoring (and bottle depletion). In other embodiments, such sensors can be located on the suction end of hoses (the connection at the fire hydrant) to inform the pump operator about the pressure available at the hydrant (he or she could be around the block or down the street and needs to know if the supply pressure is falling whether it is because someone parked on the hose or the pressure in the main is falling). The disclosed embodiments can be utilized to provide information to a firefighter using the tool and to the commanders and truck operator. That is, for example, a firefighter can stick a probe into a wall and utilize a radio headset to receive temperature information. The breathing apparatus can be equipped with a sensor that senses the surrounding air and indicates to the emergency responder whether it is safe to take off his or her mask.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

What is claimed is:

1. A system, comprising:
at least one sensor integrated with an emergency response tool for use by an emergency responder in order to sense at least one parameter with respect to an emergency response environment;
a wireless communication medium for wirelessly transferring data associated with said at least one parameter to a radio communication device, wherein said data is converted to an audible signal for said emergency responder utilizing said emergency response tool; and
a transmitter for transmitting a signal representative of said data from said radio communications device to a base station as a radio signal to thereby provide useful information to an emergency response team without increasing a workload with respect to said emergency responder.

2. The system of claim 1 further comprising emergency responder gear integrated with said radio communications device to permit location and health monitoring and additionally provide said useful information to said emergency responder.

3. The system of claim 1 wherein said at least one parameter comprises at least one of the following types of parameters:
pressure;
flow rate;
temperature;
gas concentration; and
pulse rate.

4. The system of claim 1 wherein said wireless communication medium comprises a Bluetooth communication medium.

5. The system of claim 1 wherein said emergency response tool comprises a firefighting tool.

6. The system of claim 5 wherein said firefighting tool comprises an instrumented fire hose tool.

7. The system of claim 5 wherein said firefighting tool comprises an instrumented fire pike pole tool.

8. The system of claim 7 wherein said at least one sensor is mounted in proximity to a nozzle associated with said instrumented fire hose tool, wherein said at least one parameter is detected and reported with respect to a condition at an end of said fire hose tool via said radio communication device.

9. The system of claim 8 further comprising wherein said at least one parameter with respect to said emergency response environment is reported from said sensor associated with said fire pike pole tool to said emergency responder via said radio communication device.

10. A system, comprising:
at least one sensor integrated with an emergency response tool for use by an emergency responder in order to sense at least one parameter with respect to an emergency response environment;
a wireless communication medium for wirelessly transferring data associated with said at least one parameter to a radio communication device, wherein said data is converted to an audible signal for said emergency responder utilizing said emergency response tool;
a transmitter for transmitting a signal representative of said data from said radio communication device to a base station as a radio signal to thereby provide useful information to an emergency response team without increasing a workload with respect to said emergency responder; and
emergency responder gear integrated with said radio communication device to permit location and health monitoring and additionally provide said useful information to said emergency responder.

11. A method, comprising:
integrating at least one sensor with respect to an emergency response tool for use by an emergency responder in order to sense at least one parameter with respect to an emergency response environment;
wirelessly transferring data associated with said at least one parameter to a radio communication device via a wireless communication medium;
converting said data to an audible signal for said emergency responder utilizing said emergency response tool; and
transmitting a signal representative of said data from said radio communication device to a base station as a radio signal to thereby provide useful information to an emergency response team without increasing a workload with respect to said emergency responder.

12. The method of claim 1 further comprising integrating said radio communication device with emergency responder gear to enable location and health monitoring and to provide said useful information.

13. The method of claim 1 further comprising analyzing said signal representative of said data in order to obtain a conclusion by said analysis.

14. The method of claim 1 wherein said at least one parameter comprises at least one of the following types of parameters:
pressure;
flow rate;
temperature;
gas concentration; and
pulse rate.

15. The method of claim 1 wherein said wireless communication medium comprises a Bluetooth communication medium.

16. The method of claim 1 wherein said emergency response tool comprises a firefighting tool.

17. The method of claim 16 wherein said firefighting tool comprises an instrumented fire hose tool.

18. The method of claim 16 wherein said firefighting tool comprises an instrumented fire pike pole tool.

19. The method of claim 18 further comprising:
mounting said at least one sensor in proximity to a nozzle associated with said instrumented fire hose tool; and
detecting and reporting said at least one parameter with respect to a condition at an end of said fire hose tool via said radio communication device.

20. The method of claim 18 further comprising:
reporting said at least one parameter with respect to said emergency response environment from said sensor associated with said fire pike pole tool to said emergency responder via said radio communication device.
